(19) United States
(12) Patent Application Publication
(10) Pub. No.: US 2007/0191089 A1
(43) Pub. Date: Aug. 16, 2007

(54) Gaming machine and gaming system

(75) Inventor: Kazumasa Yoshizawa, Tokyo (JP)

Correspondence Address: ARENT FOX PLLC, 1050 CONNECTICUT AVENUE, N.W., SUITE 400, WASHINGTON, DC, 20036, US

(73) Assignee: Aruze Corporation

(21) Appl. No.: 11/544,012

(22) Filed: Oct. 6, 2006

(30) Foreign Application Priority Data
Oct. 7, 2005 (JP) 2005-294599

(51) Int. Cl. A63F 13/00

(52) U.S. Cl. 463/20

(57) ABSTRACT

After a part of coins betted is added to the progressive Jack Pot, if it is determined that the Jack Pot is won (S46: YES), coins corresponding to the progressive Jack Pot accumulated up to now are paid out (S48). And on the other hand, three numbers of times of the game to start the ceiling value symbol combination are determined as the ceiling value symbol combination and coins corresponding to the payout preset are paid out (S45) every the total number of times of the game reaches to three numbers of times of the game to start the ceiling value symbol combination determined in the above (S44: YES).

### CROSS-REFERENCE TO THE RELATED APPLICATIONS (S)

This application is based upon and claims a priority from the prior Japanese Patent Application No. 2005-294599 filed on Oct. 7, 2005, the entire contents of which are incorporated herein by reference.

### BACKGROUND OF THE INVENTION

1. Field of the Invention

The present invention relates to a gaming machine and a gaming system, in which a progressive Jack Pot system is conducted.

2. Description of Related Art

Conventionally, in a gaming system in which a plurality of gaming machines such as slot machines are linked, it is adopted a system called as a progressive Jack Pot that a predetermined rate of coins betted in each gaming machine is pooled among all coins betted in the gaming machines, and coins pooled are paid out at one time when a specific winning combination with a low appearance probability is realized (for example, see Unexamined Japanese Publication No. 2004-130119).

And in the system called as the progressive Jack Pot, there will be a case that such progressive Jack Pot system is independently conducted with no relation whether or not many gaming machines are linked.

And in the system called as the progressive Jack Pot, for example, according to the above case, a probability according to which the specific winning combination appears and is realized is usually set low, therefore there will be many cases that polled coins become enormous. Thus, the real pleasure for a dream of making a fortune at a stroke can be given to a player.

However, even if the player really continues to play games while aiming the progressive Jack Pot, there will be scarcely a case that the player can get luck to obtain the pooled coins, therefore it is not enough make the player have interest to continue games.

### SUMMARY OF THE INVENTION

Thus, the present invention has been done and has an object to provide a gaming machine and a gaming system in which interest of the player to continue games can be aroused even in a case that the player gives up to obtain realizing of the progressive Jack Pot.

In order to accomplish the above object, according to one aspect of the present invention, it is provided a gaming machine comprising:

a display device for variably displaying and stopping symbols based on a bet amount;

a processor programmed to operate with the display device (a) to conduct a lottery to determine a stop display manner of the symbols on the display device, (b) to control the display device to stop the symbols according to the stop display manner, (c) to give a payout based on the stop display manner of the symbols, (d) to conduct a lottery to determine whether or not a progressive Jack Pot to which a part of the bet amount is accumulated every a game is won, (e) to pay out the progressive Jack Pot when the progressive Jack Pot is won, (f) to conduct a lottery to determine at least one threshold among plural thresholds, and (g) to give a predetermined award different from the payout based on the stop display manner and the progressive Jack Pot when the threshold is realized.

And according to another aspect of the present invention, it is provided a gaming system in which plural gaming machines and a server are connected,

wherein each of the gaming machine comprising;

a display device for variably displaying and stopping symbols based on a bet amount; and

a gaming machine processor programmed to operate with the display device (a) to conduct a lottery to determine a stop display manner of the symbols on the display device, (b) to control the display device to stop the symbols according to the stop display manner, and (c) to give a payout based on the stop display manner of the symbols;

wherein the server comprising:

a server processor (d) to conduct a lottery to determine whether or not a progressive Jack Pot to which a part of the bet amount betted in each of the gaming machines is accumulated every a game is won, (e) to pay out the progressive Jack Pot to the gaming machine that a part of the bet amount is accumulated to the progressive Jack Pot when the progressive Jack Pot is won, (f) to conduct a lottery to determine at least one threshold among plural thresholds, and (g) to give to the gaming machine that a part of the bet amount is accumulated to the progressive Jack Pot a predetermined award different from the payout based on the stop display manner and the progressive Jack Pot when the threshold is realized.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view of a slot machine,

FIG. 2 is a block diagram schematically showing a control system of the slot machine,

FIG. 3 is a block diagram schematically showing a liquid crystal drive circuit of a liquid crystal display,

FIG. 4 is an explanatory view for explaining symbol columns variably displayed and stopped while scrolling in each of variable display portions, each of the symbol columns being formed on a periphery of each reel,

FIG. 5 is an explanatory view showing a lottery table of stop display symbols,

FIG. 6 is en explanatory view showing winning symbol combinations and payouts thereof,

FIG. 7 is a flowchart of a main process program,

FIG. 8 is a flowchart of a start acceptance process program,

FIG. 9 is a flowchart of a lottery process program,

FIG. 10 is a flowchart of a game process program,

FIG. 11 is an explanatory view showing lottery tables for a number of times of a game to start a ceiling value symbol combination and payout tables of the ceiling value symbol combination with effect notification,

FIG. 12 is an explanatory view showing a lottery table of the number of times of the game necessary to start the ceiling value symbol combination and a payout table of the ceiling value symbol combination and effect notification,

FIG. 13 is an explanatory view showing a lottery table of the stop display symbols,

FIG. 14 is a system block diagram showing a slot system,

FIG. 15 is a block diagram schematically showing a control system of the slot machine constructing the slot system,

FIG. 16 is a block diagram schematically showing a control system of a server constructing the slot system,

FIG. 17 is a flowchart of a main process program conducted in each slot machine of the slot system,

FIG. 18 is a flowchart of a start acceptance program conducted in each slot machine of the slot system,

FIG. 19 is a flowchart of a lottery process program conducted in each slot machine of the slot system,

FIG. 20 is a flowchart of a game process program conducted in each slot machine of the slot system, and

FIG. 21 is a flowchart of a lottery process program for Jack Pot and ceiling value symbol combination, the program being conducted in the server of the slot system.

### DETAILED DESCRIPTION OF THE PREFERRED EMBODIMENTS

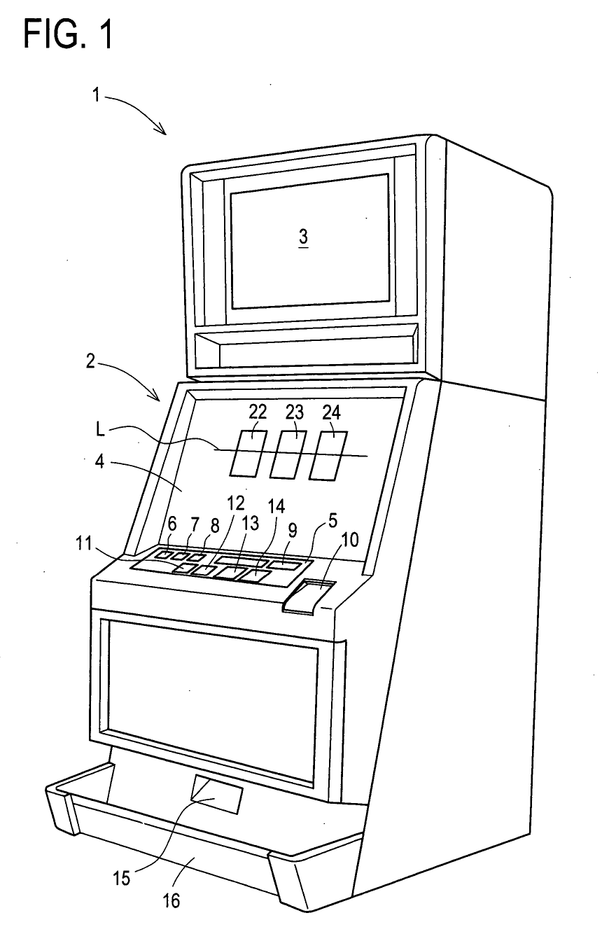

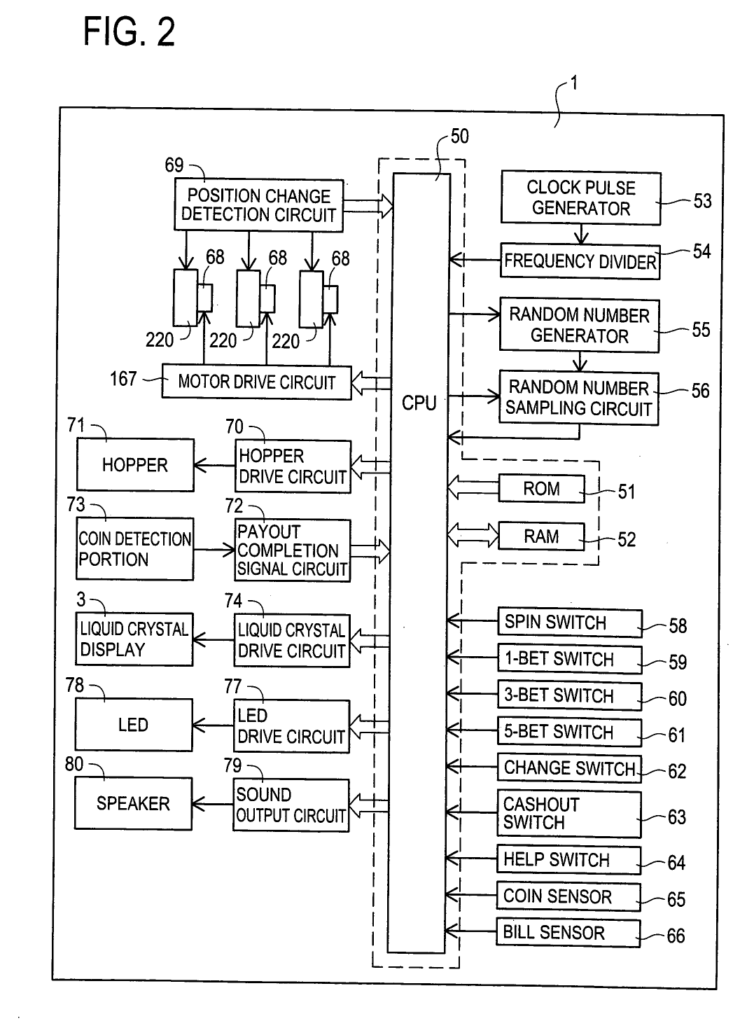

Hereinafter, a gaming machine according to the present invention will be described in detail based on an embodiment which is embodied in a slot machine, with reference to the drawings. At first, an outline construction of the slot machine according to the embodiment will be described with reference to FIGS. 1 and 2. FIG. 1 is a perspective view of the slot machine. FIG. 2 is a block diagram schematically showing a control system of the slot machine.

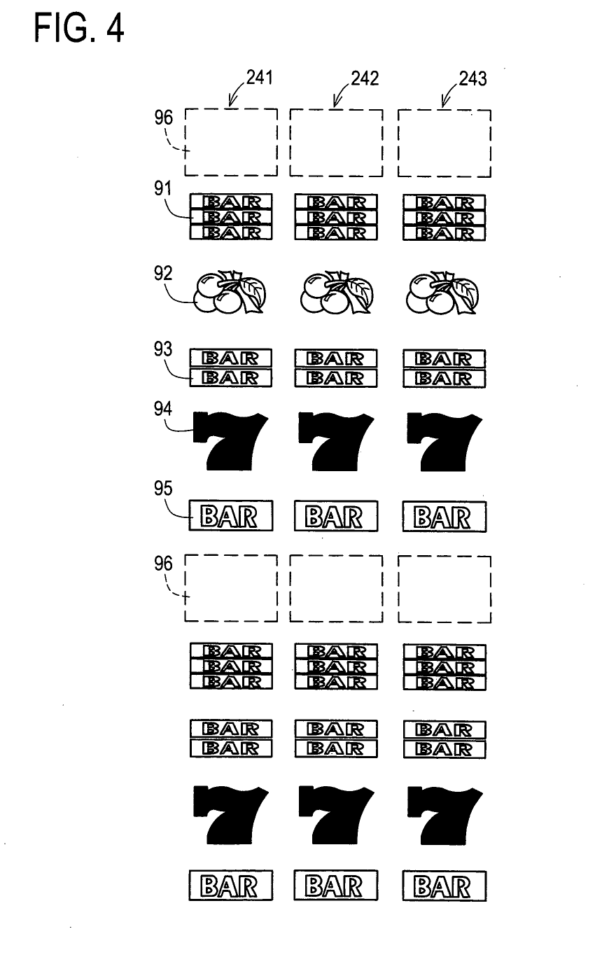

In FIG. 1, the slot machine 1 has a cabinet 2 constructing whole construction of the slot machine 1. At a front upper position of the cabinet 2, a liquid crystal display 3 is arranged, and at a front center position of the cabinet 2, a front panel 4 is arranged. Here, the liquid crystal display 3 is constructed from a liquid crystal display which is generally used. And on the liquid crystal display 3, it is displayed information concerning with a game such as game methods, kinds of winning combinations and payouts thereof, various effects and the like. And on the front panel 4, three variable display portions 22, 23, and 24 and an active pay line L are provided, and various kinds of symbols mentioned later are variably displayed on each of the variable display portions 22, 23, 24 while being scrolled from an upper direction toward a lower direction (see FIG. 4 mentioned later).

At an lower side of the front panel 4, it is provided a control panel 5 forwardly projected, and on the control panel 5, a CHANGE button 6, a CASHOUT button 7 and a HELP button 8 are arranged from the most left side of the control panel 5. At the right side of the HELP button 8, a coin insertion slot 9 and a bill insertion portion 10 are provided. Further, in the forward side of the control panel 5, there are provided a 1-BET button 11, a SPIN (SPIN/REPEAT BET) button 12, a 3-BET button 13 and a 5-BET button 14 from the left side of the control panel 5.

Here, the CHANGE button 6 is a button which is pressed when a bill inserted in the bill insertion portion 10 is exchanged with coins, and coins exchanged are paid out from a coin payout opening 15 to a coin receiver 16, both of which are provided at lower positions of the cabinet 2. To the CHANGE button 6, a CHANGE switch 62 mentioned later is attached and a switch signal is output from the CHANGE switch 62 to a CPU 50 based on press operation of the CHANGE button 6 (see FIG. 2).

The CASHOUT button 7 is a button which is pressed when the game is terminated, and when the CASHOUT button 7 is pressed, coins obtained in the game are paid out from the coin payout opening 15 to the coin receiver 16. Here, to the CASHOUT button 7, a CASHOUT switch 63 mentioned alter is attached and a switch signal is output from the CAHSOUT switch 63 to the CPU 50 based on press operation of the CAHSOUT button 7 (see FIG. 2).

The HELP button is a button which is pressed when operation methods of the game cannot be understood, and when the HELP button 8 is pressed before the game is started, various help information is displayed on the liquid crystal display 3. Here, when the HELP button 8 is pressed during the game, a total number of times of the game are displayed on the liquid crystal display 3. To the HELP button 8, a HELP switch 64 mentioned later is attached, and a switch signal is output from the HELP switch 64 to the CPU 50 based on press operation of the HELP button 8 (see FIG. 2).

To the coin insertion slot 9, a coin sensor 65 mentioned later is arranged and when coins are inserted in the coin insertion slot 9, a coin detection signal is output to the CPU 50 through the coin sensor 65 (see FIG. 2).

To the bill insertion portion 10, a bill sensor 66 mentioned later is arranged and when a bill is inserted in the bill insertion portion 10, a bill detection signal is output to the CPU 50 through the bill sensor 66 (see FIG. 2).

The 1-BET button 11 is a button through one press of which one bet is betted. To the 1-BET button 11, a 1-BET switch 59 mentioned later is attached, and when the 1-BET button is pressed, a switch signal is output from the 1-BET switch 59 to the CPU 50 based on press operation of the 1-BET button 11.

The SPIN button 12 is a button to start the game with a bet number in the previous time or at preset on the basis of press thereof. To the SPIN button 12, a SPIN switch 58 mentioned later is attached, and when the Spin button 12 is pressed, a switch signal is output from the Spin switch 58 to the CPU 50 based on press operation of the SPIN button 12 (see FIG. 2). Here, as for the bet number bettable based on press of the SPIN button 12, there will exist 1 bet, 2 bets, 3 bets and 5 bets.

The 3-BET button 13 is a button through press of which 3 bets can be done. To the 3-BET button 13, a 3-BET switch 60 mentioned later is attached, and when the 3-BET button is pressed, a switch signal is output from the 3-BET switch 60 to the CPU 50 (see FIG. 2). And the 5-BET button 14 is a button through press operation of which 5 bets can be done. To the 5-BET button 14, a 5-BET switch 61 mentioned later is attached, and when the 5-BET button is pressed, a switch signal is output from the 5-BET switch 61 to the CPU 50 based on press operation of the 5-BET button 14 (see FIG. 2).

And at a lower position of the cabinet 2, the coin payout opening 15 is formed and the coin receiver 16 to receive coins paid out from the coin payout opening 15 is formed. Within the coin payout opening 15, a coin detection portion 73 (mentioned later), which is constructed from a sensor or the like, is arranged. The coin detection portion 73 detects a number of coins paid out from the coin payout opening 15 (see FIG. 2).

And at a rear side of the front panel 4, three reels 220 are rotatably supported in a parallel state so as to be able to independently rotate (see FIG. 2). And the game is conducted by using the symbols of the reels 220 which can be seen through each of the variable display portions 22 to 24 of the front panel 4.

Here, each of the reels 220 will be described. Among three reels 220, the left reel 220 defined by seeing the front plane of the slot machine 1 faces to the left variable display portion 22 formed on the front panel 4. Similarly, the center reel 220 faces to the center variable display portion 23 formed on the front panel 4 of the slot machine 1. Further, the right reel 220 faces to the right variable display portion 24 formed on the front panel 4 of the slot machine 1.

Next, with reference to FIG. 4, it will be described symbol columns which are variably displayed and stopped in each of the variable display portions 22 to 24. In FIG. 4, a symbol column 241 is a symbol column which are variably displayed and stopped in the left variable display portion 22, a symbol column 242 is a symbol column which is variably displayed and stopped in the center variable display portion 23 and a symbol column 243 is a symbol column which is variably displayed and stopped in the right variable display portion 24.

Here, each of the symbol columns 241 to 243 mutually has the same symbol arrangement. Each symbol column is constructed from eleven symbols obtained by voluntarily combining triple BAR 91, cherry 92, double BAR 93, seven 94, single BAR 95 and blank 96 (area that no symbol exists).

Here, in a case that each of the symbol columns 241 to 243 variably displayed while scrolling in each of the variable display portions 22 to 24 is displayed and stopped, three symbols are stopped and displayed in each of the variable display portions.

And various winning symbol combinations are set beforehand based on plural kinds of symbol combinations, and when the symbol combination corresponding to the winning symbol combination are stopped on the activated pay line L, coins are paid out corresponding t the winning symbol combination. This operation is as same as that in the conventional slot machine. Therefore, explanation thereof will be omitted.

And in a case that various symbols are formed on a peripheral of each reel 220, it is a general method that eleven symbols are printed on a long reel sheet having a width and a peripheral length as same as those of each reel 220 and this reel sheet is adhered to the peripheral of each reel 220. Of course, the symbols can be formed by methods other than the above method.

Next, a control system of the slot machine 1 will be described with reference to FIG. 2. FIG. 2 is a block diagram schematically showing a control system of the slot machine 1.

In FIG. 2, the control system of the slot machine 1 is basically constructed from a CPU 50 which is a main component. To the CPU 50, a ROM 51 and a RAM 52 are connected. In the ROM 51, it is stored a main process program mentioned later, a lottery and stop control process program, various effect process programs to conduct various effects on the liquid crystal display 3 according to progress of the game, a lottery table used in a lottery of stop display symbols in the game, other various programs necessary for control in the slot machine 1 and data tables. And The RAM 52 is a memory to temporarily store various data calculated by the CPU 50.

And to the CPU 50, a clock pulse generator 53 generating standard clock pulses and a frequency divider 54 are connected, and a random number generator 55 generating random numbers and a random number sampling circuit 56 are connected. A random number sampled by the random number sampling circuit 56 is used in various lotteries of the winning symbol combination and the like. Further, to the CPU 50, it is respectively connected a SPIN switch 58 attached to the SPIN button 12, a 1-BET switch 59 attached to the 1-BET button 11, a 3-BET switch 60 attached to the 3-BET button 13, a 5-BET switch 61 attached to the 5-BET button 14, a CHANGE switch 62 attached to the CHANGE button 6, a CASHOUT switch 63 attached to the CASHOUT button 7 and a HELP switch 64 attached to the HELP button 8. The CPU 50 conducts control to execute various operations corresponding to each button based on the switch signal output from each switch through press operation of each button.

To the CPU 50, three stepping motors 68 to rotate each of the reels 220 through a motor drive circuit 167 are connected and a position change detection circuit 69 is connected. When a motor drive signal (instruction pulses) is output to the motor drive circuit 167 from the CPU 50, each of the stepping motors 68 is driven to rotate by an excitation signal output from the motor drive circuit 167, thereby rotation of each reel 220 is conducted.

At that time, the CPU 50 counts a number of drive pulses provided to each stepping motor 68 and recognizes rotation positions of the symbols in each reel 220 based on the number of drive pulses counted, thereafter conducts stop position control of the symbols.

The position change detection circuit 69 connected to the CPU 50 detects change of the stop position of the reel 220 after stop control of the reels 220 is conducted by the motor drive circuit 167.

Further, to the CPU 50, a coin sensor 65 arranged in the coin insertion slot 9 and a bill sensor 66 arranged in the bill insertion portion 10 are respectively connected. The coin sensor 65 detects coins inserted from the coin insertion slot 9 and the CPU 50 calculates a number of inserted coins based on a coin detection signal output from the coin sensor 65. The bill sensor 66 detects a kind and sum of the bill inserted in the bill insertion portion 10 and the CPU 50 calculates a number of coins equivalent to the sum of bill based on a bill detection signal output from the bill sensor 66.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged within the coin payout opening 15, and when the coin detection portion 73 detects that a predetermined number of coins are paid out from the coin payout opening 15, a coin payout detection signal is output to the payout completion signal circuit 72 from the coin detection portion 73. Based on this, the payout completion signal circuit 72 outputs a payout completion signal to the CPU 50. Further, to the CPU 50, the liquid crystal display 3 is connected through a liquid crystal drive circuit 74, and the liquid crystal display 3 is controlled by the CPU 50.

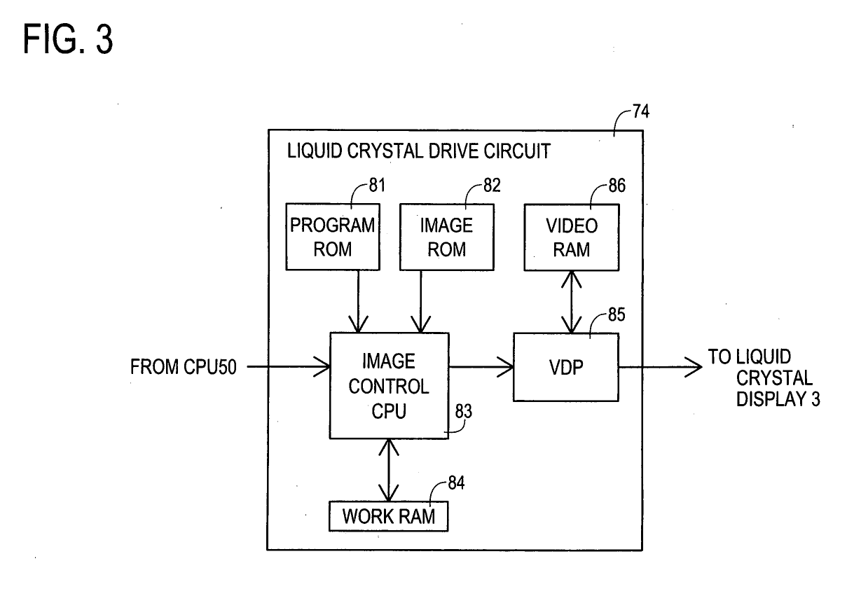

Here, as shown in FIG. 3, the liquid crystal drive circuit 74 is constructed from a program ROM 81, an image ROM 82, an image control CPU 83, a work RAM 84, a VDP 85 (Video Display Processor) and a video RAM 86. And in the program ROM 81, an image control program concerning with display on the liquid crystal display 3 and various selection tables are stored. And in the image ROM 82, for example, dot data for forming images displayed on the liquid crystal display 3 are stored. Further, the image control CPU 83 determines the image displayed on the liquid crystal display 3 among the dot data stored beforehand in the image ROM 82, according to the image control program stored beforehand in the program ROM 81 based on parameters set by the CPU 50. And the work RAM 84 is constructed as a temporary memory used when the image control program is executed by the image control CPU 83. Further, the VDP 85 forms the image corresponding to display contents determined by the image control CPU 83 and outputs it to the liquid crystal display 3. Here, the video RAM 86 is constructed as a temporary memory when images are formed by the VDP 85.

Returning to FIG. 2, LEDs 78 are connected to the CPU 50 through a LED drive circuit 77. Many LEDs 78 are arranged on the front plane of the slot machine 1 and are controlled so as to turn on and off through the LED drive circuit 77 based on drive signals from the CPU 50 when various effects are conducted. Further, a sound output circuit 79 and a speaker 80 are connected to the CPU 50 and the speaker 80 outputs various sounds based on an output signal from the sound output circuit 79 when various effects are conducted.

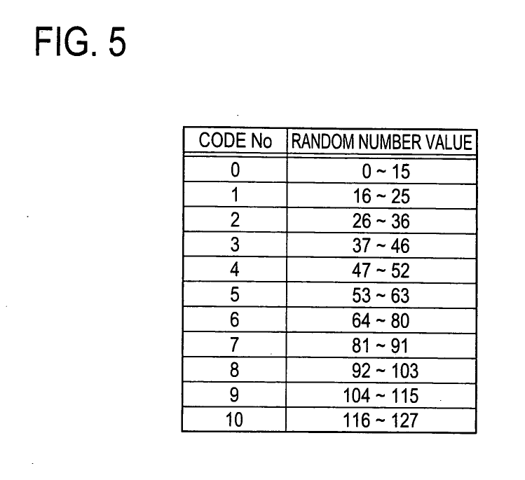

Here, with reference to FIG. 5, it will be described a lottery table which is used when the symbols stopped and displayed on the activated pay line L are determined while the game is conducted by using three variable display portions 22 to 24 in the slot machine 1. FIG. 5 is an explanatory view showing a lottery table of the stop display symbols used when the game is conducted by using three variable display portions.

The symbol stopped and displayed on the activated pay line L is determined every each of variable display portions 22 to 24. In order to realize this, code numbers “0”˜“10” are allotted to the symbols in order from the uppermost symbol in each of the symbol columns 241 to 243 respectively corresponding to each of the variable display portions 22 to 24. Further, a table shown in FIG. 5 is prepared. And three random numbers corresponding to each of the variable display portions 22 to 24 are sampled through the random number sampling circuit 56.

Hereinafter, for convenience' sake, the symbol column 241 of the left variable display portion 22 is described as “left reel”, the symbol column 242 of the center variable display portion 23 is described as “center reel” and the symbol column 243 of the right variable display portion 24 is described as “right reel”.

Here, as for the “left reel” of the symbol column 241 in the left variable display portion 22, as shown in the lottery table of FIG. 5, if the random number sampled by the random number sampling circuit 56 lies in a range of 0˜15, the blank 96 allotted to the code number “0” is stopped and displayed on the activated pay line L. Similarly, as for each of the code numbers of “1”˜“10”, the symbol stopped and displayed on the activated pay line L is determined based on the lottery table shown in FIG. 5.

As for the “center reel” of the symbol column 242 of the center variable display portion 23 and the “right reel” of the symbol column 243 of the right variable display portion 24, the same process as the “left” reel of the symbol column 241 of the left variable display portion 22 is conducted.

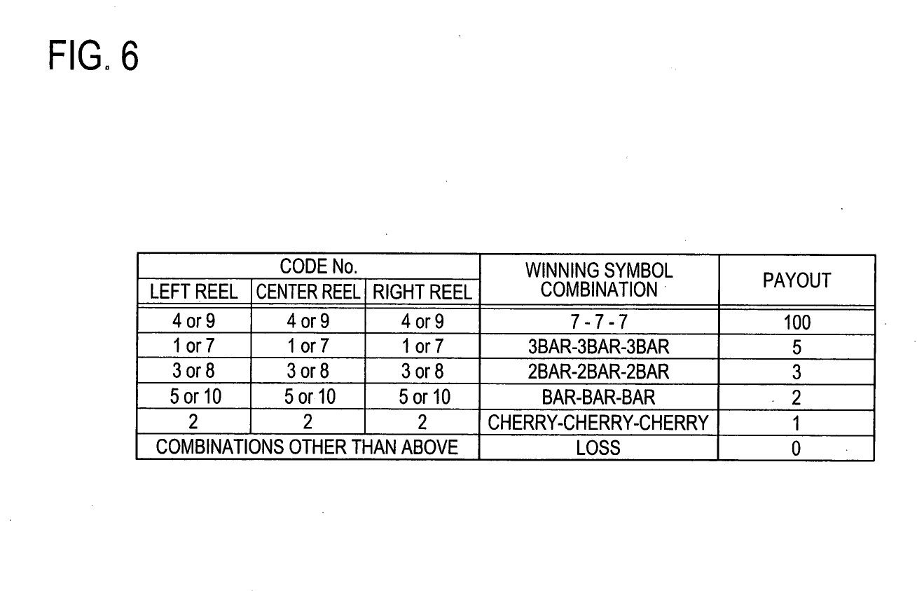

Next, with reference to FIG. 6, it will be described winning symbol combinations and payouts thereof in a case that the game is conducted by using three variable display portions 22 to 24 in the slot machine 1. FIG. 6 is an explanatory view showing winning symbol combinations and payouts thereof in a case that the game is conducted by using three variable display portions. In FIG. 6, in a case that the code number of the “left reel”, the “center reel” and the “right reel ” is “4” or “9”, the winning symbol combination “7-7-7” is won. In this case, the symbol seven 94 is stopped and displayed on the activated pay line L in all of the variable display portions 22 to 24, and the payout “100” is obtained. Similarly to the above, each of the payout “5”, “3”, “2” and “1” is done based on the table shown in FIG. 6.

Here, in a case that the code number of the “left reel”, the “center reel ” and the “right reel” is determined as a combination other than the combinations shown in FIG. 6, the game is lost. In this case, although any of the triple BAR 91, the cherry 92, the double BAR 93, the seven 94, the single BAR 95 or the blank 96 is stopped and displayed on the activated pay line L in each of the variable display portions 22 to 24, the payout cannot be obtained.

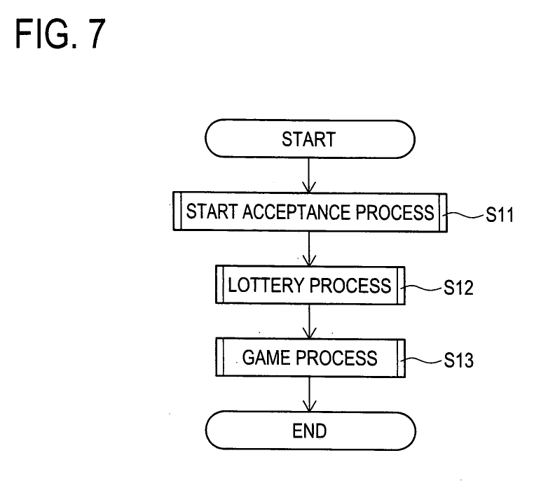

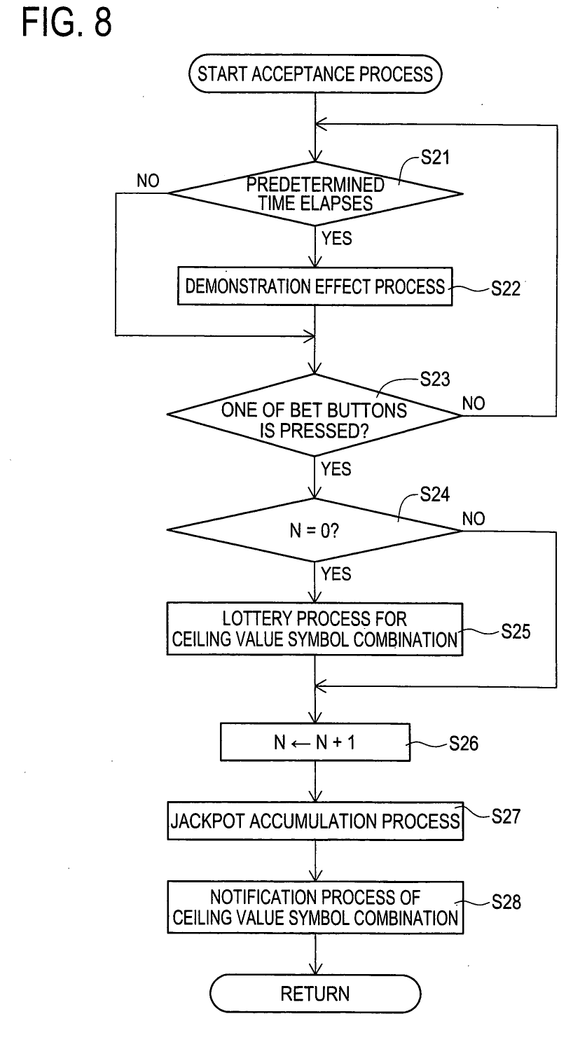

Next, a main process program executed in the slot machine 1 will be described with reference to FIG. 7. FIG. 7 is a flowchart of the main process program. In FIG. 7, at first, in step (abbreviated as “S” hereinafter) 11, a start acceptance process of FIG. 8 mentioned later is conducted. This process is a process to accept the switch signal output from the SPIN switch 58, the I-BET switch 59, the 3-BET switch 60 or the 5-BET switch 61 based on operation of the SPIN button 12, the 1-BET button 11, the 3-BET button 13 or the 5-BET button 14. Here, at the time that the switch signal output from each switch is accepted, the game is started.

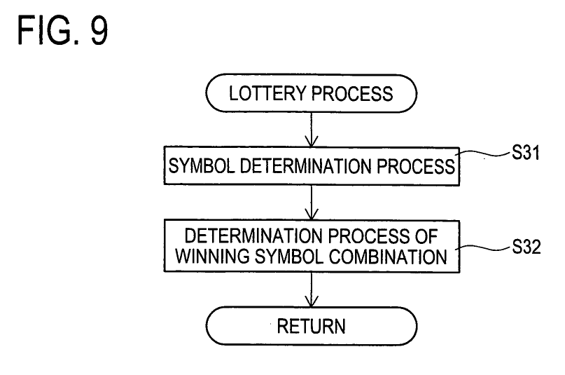

And in S12, a lottery process of FIG. 9 mentioned later is conducted based on the switch signal output from the SPIN switch 58, the 1-BET switch 58, the 3-BET switch 60 or the 5-BET switch 61.

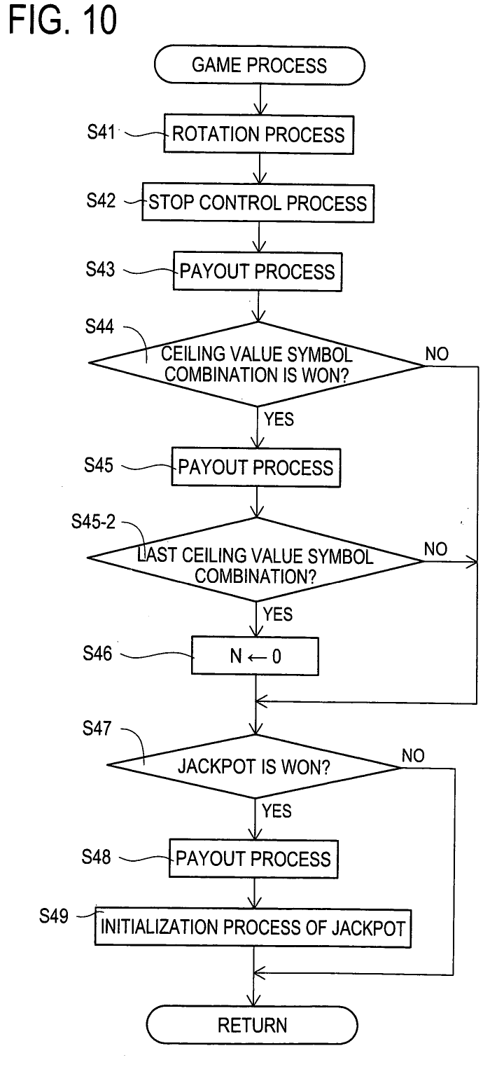

Next, in S13, a game process of FIG. 10 mentioned later is conducted, thereafter the main process program is terminated.

Next, the start acceptance process program done in the slot machine 1 will be described with reference to FIG. 8. FIG. 8 is a flowchart of the start acceptance process program. After the start acceptance process of FIG. 7 is started in S11, procedure shifts to S21 of FIG. 8. In S21, it is determined whether or not a predetermined time (for example, 15 seconds) elapses. Here, if it is determined that the predetermined time does not elapse (S21: NO), procedure shifts to S23. On the other hand, if it is determined that the predetermined time elapses (S21: YES), demonstration effect is conduced on the liquid crystal display 3 in S22. Thereafter, procedure shifts to S23. And in S23, it is determined whether or not the SPIN button 12, the 1-BET button 11, the 3-BET button 13 or the 5-BET button 14 is operated. If it is determined that any one of the buttons is not operated (S23: NO), procedure returns to S21 and procedures mentioned in the above are repeated. On the other hand, if it is determined that any one of the buttons is operated (S23: YES), procedure shifts to S24 even while the demonstration effect is conducted.

And in S24, it is determined whether or not the total number of times N of the game is “0”. Here, if it is determined that the total number of times N of the game is not “0” (S24: NO), procedure shifts to S26. On the other hand, if it is determined that the total number of times N of the game is “0” (S24: YES), a lottery process for ceiling value symbol combination of S25 mentioned later is conducted, thereafter procedure shifts to S26.

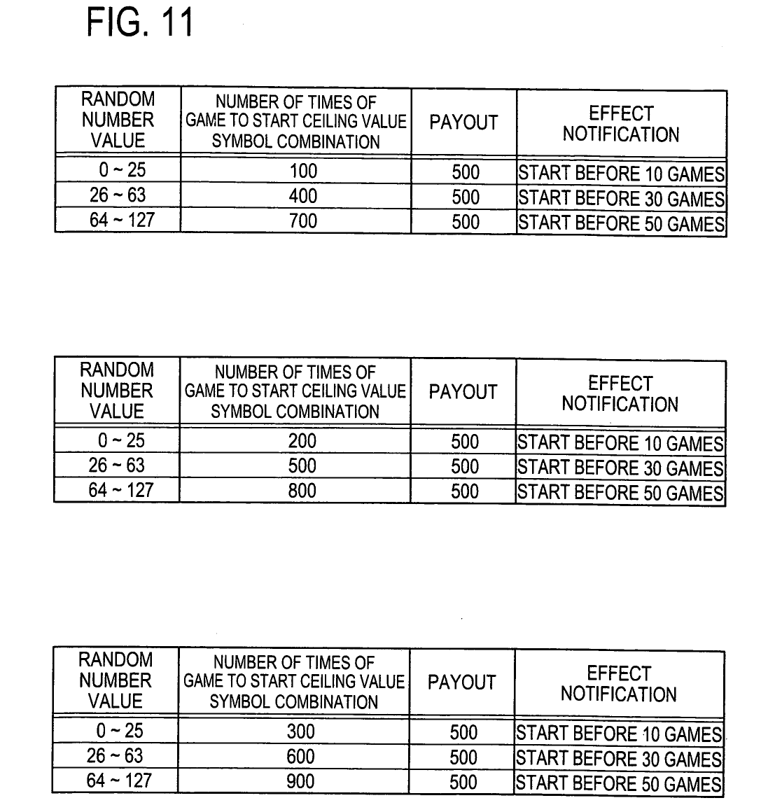

Here, the lottery process for ceiling value symbol combination in S25 will be described. FIG. 11 is an explanatory view showing lottery tables of a number of times of the game to start the ceiling value symbol combination and payout tables of the ceiling value symbol combination with effect notification. In the lottery process for the ceiling value symbol combination of S25 in FIG. 8, three random numbers are sampled within a range of 0˜127 through the random number sampling circuit 56, and one value of the number of times of the game to start the ceiling value symbol combination is determined based on each of three tables in FIG. 11. Concretely, if the first random number value sampled through the random number sampling circuit 56 lies in a range of 0˜25, “100” is determined as the number of times of the game to start the ceiling value symbol combination based on the upper table in FIG. 11. And if the second random number value sampled through the random number sampling circuit 56 lies in a range of 26˜63, “500” is determined as the number of times of the game to start the ceiling value symbol combination based on the middle table in FIG. 11. Further, if the third random number value sampled through the random number sampling circuit 56 lies in a range of 64˜127, “900” is determined as the number of times of the game to start the ceiling value symbol combination based on the lower table in FIG. 11. That is to say, three ceiling values of the number of times of the game to start the ceiling value symbol combination are determined in the lottery process for ceiling value symbol combination in S25.

Here, the ceiling value symbol combination is a symbol combination through which a payout is given when the total number of times N of the game reaches to the value (threshold) determined as the number of times of the game to start the ceiling value symbol combination. For example, in the lottery process for the ceiling value symbol combination in S25, if three of the number of times of the game necessary to start the ceiling value symbol combination, each of which is determined based on each of three tables in FIG. 11, are respectively “400”, “800”, “300”, every the total number of times N of the game becomes “300”, “400” and “800”, the payout of “500” is given. Here, the total number of times N of the game is stored in a memory area formed in the RAM 52, and after the payout is given, the total number of times N of the game is initialized to “0” (see S46 of FIG. 10 mentioned later).

And in the lottery process for ceiling value symbol combination in S25, the lottery of plural numbers of times of the game to start the ceiling value symbol combination may be conducted beforehand through the random number sampling circuit 56, thereafter three of the number of times of the game to start the ceiling value symbol combination may be determined by a lottery among such plural numbers of times of the game to start the ceiling value symbol combination. Here, in this case, the lottery done beforehand may be conducted right before three of the number of times of the game to start the ceiling value symbol combination are determined within the lottery process for ceiling value symbol combination of S25, or for example, may be conducted when the total number of times N of the game is reset in S46 mentioned later by substituting the number N for “0”.

Returning to FIG. 8, in S26, “1” is added to the total number of times N of the game at present, thereby the total number of times N of the game in this time is calculated. Further, in S27, a Jack Pot accumulation process is conducted.

Here, in the Jack Pot accumulation process of S27, a part of coins (worth equivalent thereto) betted is added to progressive Jack Pot. Here, the progressive Jack Pot is stored in a memory area formed in the RAM 52.

And in S28, it is conducted a process to notify the ceiling value symbol combination. In this process, when the total number of times N of the game reaches to a predetermined number of times of the game smaller than the value determined as the number of times of the game to start the ceiling value symbol combination, it is thereafter notified to the player every the game is conducted that the payout for the ceiling value symbol combination is given, by displaying the tables shown in FIG. 11 on the liquid crystal display 3. Concretely, for example, in a case that three numbers of times of the game to start the ceiling value symbol combination, each of which is determined based on each of three tables in FIG. 11, are respectively “700”, “200”, “600”, when the total number of times N of the game becomes “190” which is smaller than “200” by “10”, the tables shown in FIG. 11 are displayed on the liquid crystal display 3 every the game is done till the total number of times N of the game reaches to “200”. And when the total number of times N of the game becomes “570” which is smaller than “600” by “30”, the tables shown in FIG. 11 are displayed on the liquid crystal display 3 every the game is done till the total number of times N of the game reaches to “600”. Further, when the total number of times N of the game becomes “650” which is smaller than “700” by “50”, the tables shown in FIG. 11 are displayed on the liquid crystal display 3 every the game is done till the total number of times N of the game reaches to “700”.

Thereafter, procedure returns to the main process program of FIG. 7 and shifts to the lottery process in S12.

Next, a lottery process program conducted in the slot machine 1 will be described with reference to FIG. 9. FIG. 9 is a flowchart of the lottery process program. After the lottery process is started in S12 of FIG. 7, procedure shifts to S31 of FIG. 9 and a symbol determination process is conducted. Here, the symbol stopped and displayed on the activated pay line L is determined every each of the variable display portions 22, 23, 24 during the game (S42 of FIG. 10). Concretely, as mentioned in the above, three random number values are sampled within a range of 0˜127 through the random number sampling circuit 56, so the variable display portions 22, 23, 24, and the stop display symbols are determined through the code numbers based on the lottery table shown in FIG. 5. And after the symbols stopped and displayed on the activated pay line L are determined, a winning symbol combination determination process is done in S32. In the symbol combination determination process, concretely speaking, the winning symbol combination and the payout thereof are determined based on the table in FIG. 6 through the code numbers determined in S31. Thereafter, procedure returns to the main process program and shifts to the game process in S13.

Next, the game process program conducted in the slot machine 1 will be described with reference to FIG. 10. FIG. 10 is a flowchart of the game process. After the game process is started in S13 of the main process program shown in FIG. 7, procedure shifts to s41 of FIG. 10 and a rotation process is conducted. In this rotation process, concretely speaking, the reels 220 positioned at the rear side of the variable display portions 22, 23, 24 are started to rotate based on the switch signal output from the SPIN switch 58, the 1-BET switch 59, the 3-BET switch 60 or the 5-BET switch 61, the switch signal being accepted in S11 of FIG. 7.

Thereby, thorough the variable display portions 22, 23, 24, the symbol columns 241, 242, 243 formed on the peripheries of the reels 220 are variably displayed while scrolling, thus variable display of the symbols is done.

And in S42, a stop control process is conducted. In this stop control process, concretely speaking, each of reels 220 positioned at the rear side of the variable display portions 22 to 24 is stopped every each of the variable display portions 22, 23, 24. Thereby, each of the symbol columns 241, 242, 243 formed on the peripheries of the reels 220 is stopped, thus each of the symbols is stopped and displayed.

And in S43, according to the winning symbol combination stopped and displayed in each of the variable display portions 22, 23, 24, coins corresponding to the payout which is preset are paid out based on the table in FIG. 6.

And in S44, it is determined whether or not the ceiling value symbol combination is won. This determination is done based on whether or not the total number of times N of the game calculated in S26 of FIG. 8 coincides with any of three numbers of times of the game to start the ceiling value symbol combination determined in S25 of FIG. 8. Here, if it is determined that the ceiling value symbol combination is not won (S44: NO), procedures shifts to S47. On the other hand, if it is determined that the ceiling value symbol combination is won (S44: YES), coins (for example, 500 coins) corresponding to the payout which is preset are paid out, based on the tables in FIG. 11 in S45, and in S45-2, it is determined whether or not the ceiling value symbol combination is the last ceiling symbol combination. This determination is done based on whether or not the total number of times N of the game calculated in S26 of FIG. 8 coincides with the maximum number of times of the game to start the ceiling value symbol combination among three numbers of times of the game to start the ceiling value symbol combination determined in S25 of FIG. 8. Here, if it is determined that the ceiling value symbol combination is not the last ceiling symbol combination (S45-2: NO), procedure shifts to S47. On the other hand, if it is determined that the ceiling value symbol combination is the last ceiling symbol combination (S45-2: YES), “0” is substituted for the total number of times N of the game, thereafter procedure shifts to S47.

In S47, it is determined whether or not the Jack Pot is won. In this determination, it is determined that the Jack Pot is won only if the random number value sampled within a range of 0˜1023 through the random number sampling circuit 56 is “0”. Instead, for example, it may be determined that the Jack Pot is won only if the symbol combination “7-7-7” is won in S12 of FIG. 7.

And in S47, if it is determined that the Jack Pot is not won (S47: NO), the main process program of FIG. 7 is terminated, and the main process program in FIG. 7 is newly started. On the other hand, if it is determined that the Jack Pot is won (S47: YES), coins corresponding to the progressive Jack Pot which is accumulated up to now are paid out in S48. Further, in an initialization process of the Jack Pot in S49, “0” is substituted for the progressive Jack Pot, thereby the progressive Jack Pot is reset. Thereafter, the main process program of FIG. 7 is terminated and the main process program in FIG. 7 is newly started.

As mentioned in detail, in the slot machine 1 of the embodiment, a part of coins (worth equivalent thereto) betted is added to the progressive Jack Pot (S27), thereafter if it is determined that the Jack Pot is won (S47: YES), coins (for example, 10000 coins) corresponding to the progressive Jack Pot accumulated up to now are paid out (S48). Here, as a condition to win the progressive Jack Pot, it is limited to a case that the random number value sampled within a range of 0˜1023 through the random number sampling circuit 56 is “0”. Therefore, in many cases, the progressive Jack Pot becomes enormous, thus although the real pleasure for a dream of making a fortune at a stroke can be given to the player, on the contrary, even if the player really continues to play games while aiming the progressive Jack Pot, there will be scarcely a case that the player can get luck to obtain the progressive Jack Pot. Therefore, the player generally gives up from the first to obtain realizing of the progressive Jack Pot.

However, in the slot machine of the embodiment, three numbers of times of the game to start the ceiling value symbol combination are determined (S25) based on the lottery using three random number values sampled within a range of 0˜127 through the random number sampling circuit 56 and three tables of FIG. 11, and coins corresponding to the payout (ceiling value symbol combination) which is preset, are paid out (S45) based on the tables in FIG. 11, every the total number of times N of the game reaches to each of three numbers of times of the game to start the ceiling symbol combination (S44). Thereby, if the player continues 900 slot games at maximum to aim the ceiling value symbol combination, the player can surely win the ceiling value symbol combination in three times. Therefore, even if the player gives up realizing to obtain the progressive Jack Pot that a part of coins (worth equivalent thereto) betted is accumulated every the game, interest of the player to continue the slot games can be sufficiently aroused.

Here, the payout corresponding to the ceiling value symbol combination may be set to the same value as shown in FIG. 11 with no relation to the number of times of the game to start the ceiling value symbol combination. And the payout corresponding to the ceiling value symbol combination may be set different according to the number of times of the game to start the ceiling value symbol combination.

And in the slot machine 1 of the embodiment, after the total number of times N of the game reaches to the predetermined number of times of the game smaller than the value determined as the number of times of the game to start the ceiling value symbol combination, it is notified thereafter to the player (S28) every the game is conducted that the payout corresponding to the ceiling value symbol combination is given, by displaying the tables shown in FIG. 11 on the liquid crystal display 3.

Therefore, for example, it is clear for the player that if the effect notification is not started after the total number of times N of the game becomes “90”, the ceiling value symbol combination cannot be won even if the total number of times N of the game becomes “100” and the ceiling value symbol combination can be won after the total number of times N of the game becomes more than “200”. And it is clear that if the effect notification is not started after the total number of times N of the game becomes “190”, the ceiling value symbol combination cannot be won even if the total number of times N of the game becomes “200” and the ceiling value symbol combination can be won after the total number of times N of the game becomes more than “300”. Further, it is clear that if the effect notification is not started after the total number of times N of the game becomes “290”, the ceiling value symbol combination cannot be won even if the total number of times N of the game becomes “300” and the ceiling value symbol combination can be won after the total number of times N of the game becomes more than “400”. Similarly to the above, if the effect notification is not started after the total number of times N of the game becomes “370”, “470”, “570”, “650”, “750” or “850”, it is clear for the player that the same situations as the above occur. Therefore, since an index to win the ceiling value symbol combination is provided, interest of the player to continue the slot games can be sufficiently aroused.

Here, the manner of the effect notification corresponding to the number of times of the game to start the ceiling value symbol combination are described as an example, thus it is not limited to this. For example, when the tables shown in FIG. 11 are displayed on the liquid crystal display 3, it may be displayed the difference between the total number of times N of the game at present and the number of times of the game to start the ceiling value symbol combination which is the nearest to the number N.

Here, the present invention is not limited to the embodiment and various changes, modifications can be done within the scope of the present invention.

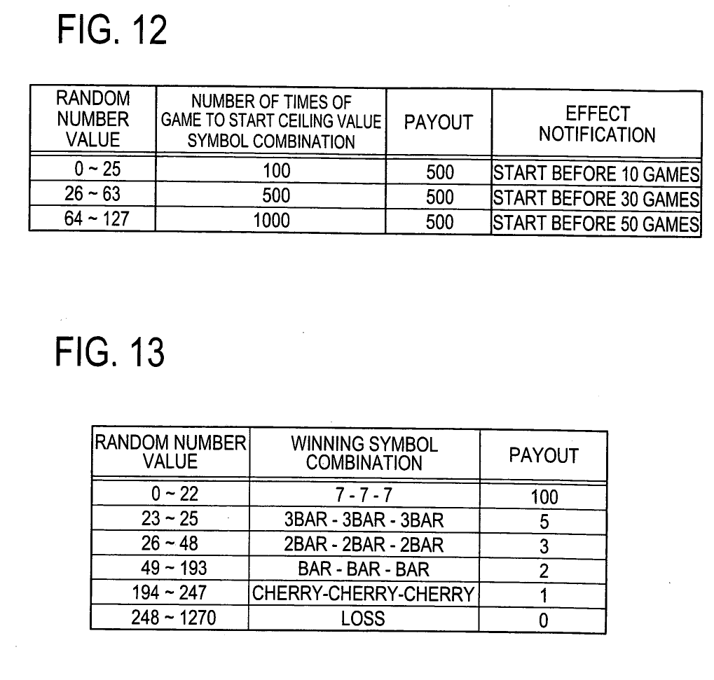

For example, in the slot machine 1 of the embodiment, although three numbers of times of the game to start the ceiling value symbol combination are determined (S25) by using three tables shown in FIG. 11 in which plural numbers of times of the game to start the ceiling value symbol combination are provided, it may be used one table in which many numbers of times of the game to start the ceiling value symbol combination are provided. And the number of times of the game to start the ceiling value symbol combination may be set to only one, and when the number of times of the game to start the ceiling value symbol combination may be determined (S25), for example, such one number of times of the game to start the ceiling value symbol combination may be determined based on one table shown in FIG. 12.

And in the slot machine 1 of the embodiment, when the HELP button 8 is pressed during the game, the total number of times N of the game is displayed on the liquid crystal display 3. Here, the total number of times N of the game may not be displayed. In this case, the player cannot acknowledge the number of times N of the game and has feeling as if coins corresponding to the payout of the ceiling value symbol combination are suddenly paid out, therefore the player expects sudden payout of coins, thereby interest of the player to continue the slot games can be sufficiently aroused.

And in the slot machine of the embodiment, although the value determined as the number of times of the game to start the ceiling value symbol combination is corresponded to the total number of times N of the game, instead of this, such value may be corresponded to the value of the progressive Jack Pot with a specific manner such as “1111”, “2222”, . . . , “9999”, “1000”, “2000”, . . . , “9000”. However, in this case, coins paid out for the ceiling value symbol combination are subtracted from the progressive Jack Pot.

Further, in the slot machine 1 of the embodiment, if it is determined that the total number of times N of the game is “0” (S24: YES), three numbers of times of the game to start the ceiling value symbol combination are determined (S25). Here, a specific operation button may be provided on the control panel 5 or the touch panel and three numbers of times of the game to start the ceiling value symbol combination may be determined based on press operation of the specific operation button.

And in the slot machine 1 of the embodiment, the symbols stopped and displayed on the activated pay line L are determined in the lottery process of S12 every each of the variable display portions 22, 23, 24 based on the random number values sampled through the random number sampling circuit 56. Here, all symbols stopped and displayed on the activated pay line L in the variable display portions 22, 23, 24 may be determined based on the random number value sampled through the random number sampling circuit 56. In order to realize this, a lottery table of the winning symbol combinations shown in FIG. 13 is used. FIG. 13 is an explanatory view showing a lottery table of the winning symbol combinations and payouts thereof.

In FIG. 13, a random number value range used in the lottery table of the winning symbol combinations is set in a range of 0˜1270, and the random number value sampled through the random number sampling circuit 56 lies in a range of 0˜22, the winning symbol combination “7-7-72 is won and the payout of “100” is obtained. Similarly, each of the payouts of “5”, “3”, “2”, “1” is determined based on the table shown in FIG. 13.

Here, if the random number value sampled lies in a range of 248˜1279, the game is lost. In this case, although the symbol combination other than the winning symbol combinations is stopped and displayed on the activated pay line L in each of the variable display portions 22, 23, 24, no coin is paid out.

And in the slot machine 1 of the embodiment, although only the base game is done, for example, a free game may be done right after the process of S13 in FIG. 7 after the base game is conducted. Here, in the free game, games beneficial for the player are generally conducted, and for example, when the free game occurs based on a condition that a specific symbol is stopped and displayed, games are continuously conducted for 10 games, 20 games or 30 games according to a rank of the free game. At that time, in the free game, a winning probability to win various winning symbol combinations is generally set high, therefore the player can obtain many coins.

And in the slot machine 1 of the embodiment, if it is determined that the ceiling value symbol combination is won (S44: YES), coins corresponding to the payout which is preset are paid out based on the tables shown in FIG. 11 (S45). Here, as the payout, instead of coins, the free game mentioned in the above may be conducted in a continuous number of times which is preset.

Further, although the slot machine 1 of the embodiment is constructed as a mechanical reel type slot machine in which the symbols formed on the peripheries of the reels 220 controlled to rotate are variably displayed and stopped through the variable display portions 22 to 24, the slot machine 1 may be constructed as a video reel type slot machine in which the image symbols are variably displayed and stopped in each of the variable display portions 22 to 24.

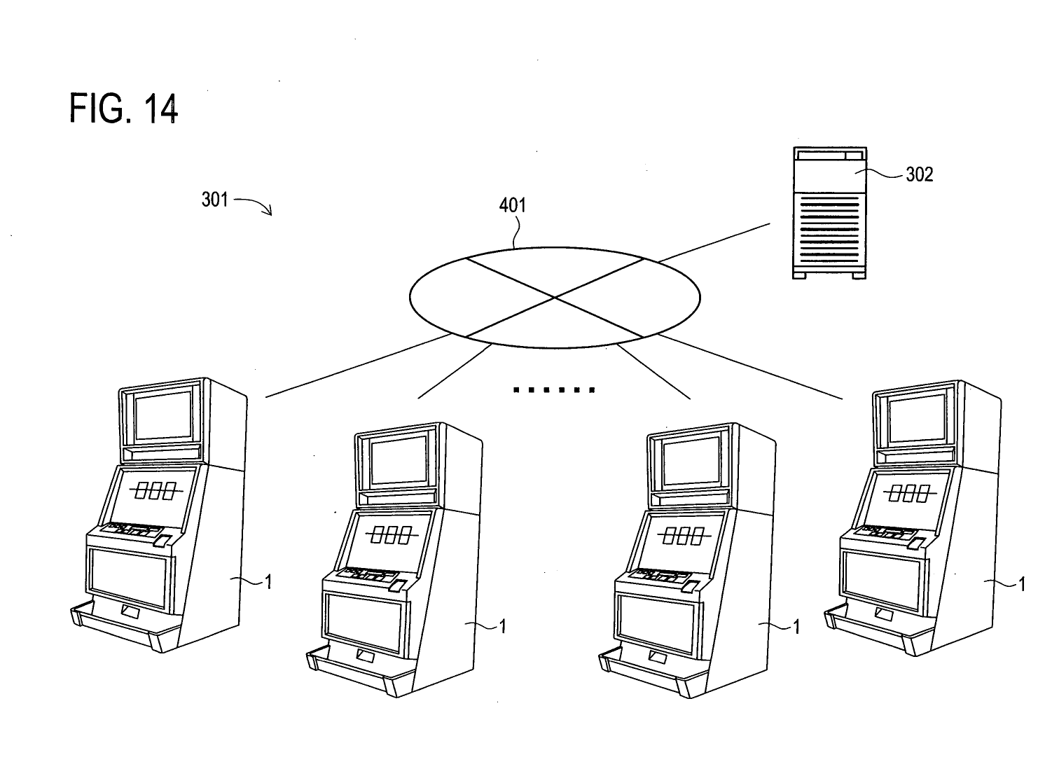

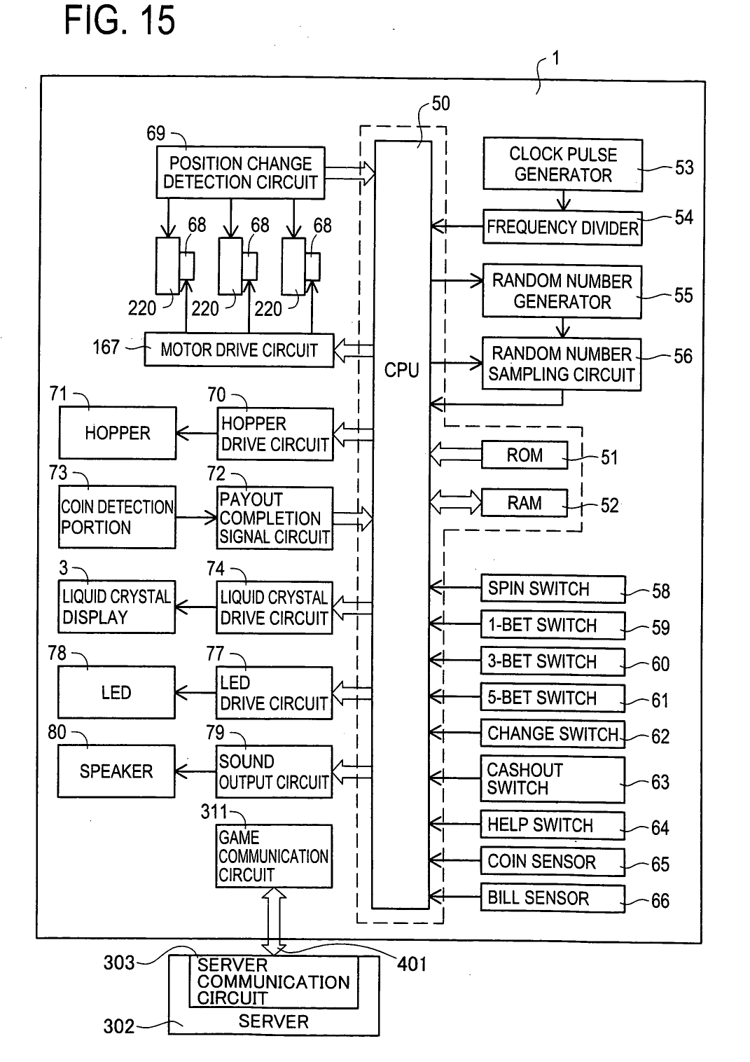

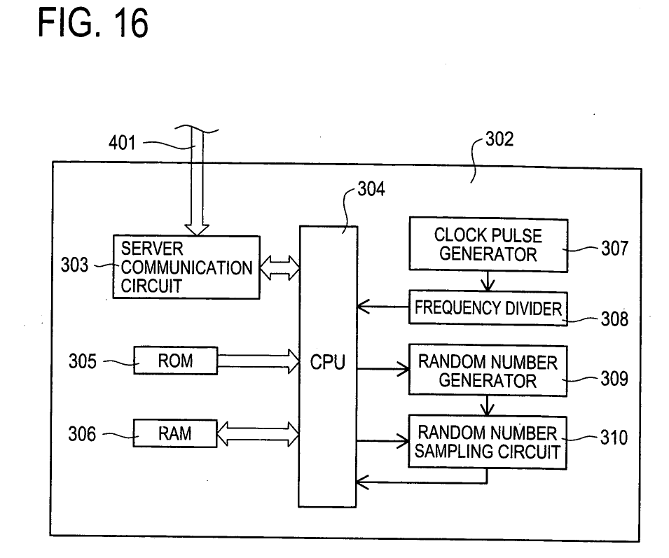

Next, a gaming system of the present invention will be described according to the embodiment embodying the present invention in a slot system, with reference to the drawings. At first, an outline construction of a slot system according to the embodiment will be described with reference to FIGS. 14˜16. FIG. 14 is a system block diagram showing a slot system of the embodiment. FIG. 15 is a block diagram schematically showing a control system of the slot machine constructing the slot system of the embodiment. FIG. 16 is a block diagram schematically showing a server control system of the slot system according to the embodiment.

Here, as for the slot machine constructing the slot system of the embodiment, such slot machine has the construction as same as that of the slot machine shown in FIGS. 1 and 2, except for a construction point mentioned hereinafter. Thus, hereinafter, to the elements as same as those in the slot machine already mentioned in the above, the same marks (numbers) as used in such slot machine will be attached and explanation thereof will be omitted. Further, the slot machine 1 shown in FIGS. 1 and 2 is as same as the slot machine used in the slot system, thus hereinafter the number “1” is attached to the slot machine in the slot system.

As shown in FIG. 14, in a slot system 301 according to the embodiment, a server 302 and a plurality of slot machines 1 are mutually connected through a network 401 with bilateral communication ability.

In each of the slot machines 1, a game communication circuit 311 is connected to the CPU 50 as shown in FIG. 15. The game communication circuit 311 converts a signal sent by the slot machine 1 into a communicable signal corresponding to a communication manner for telephone network or LAN cable. The game communication circuit 311 sends such signal to the server 302, receives the signal sent from the server 302 and reconverts the signal so that the slot machine 1 can read. And the game communication circuit 311 is connected to the server 302 through a server communication circuit 303 and the network 401 with bilateral communication ability such as Internet.

Further, as shown in FIG. 16, a control system of the server 302 is basically constructed from a CPU 304, and a ROM 305 and a RAM 306 are connected to the CPU 304. In the ROM 305, it is stored a Jack Pot and ceiling value symbol combination execution process program, a lottery table for the number of times of the game to start the ceiling value symbol combination, the table shown in FIG. 11 which is the table for ceiling value symbol combination and effect notification, other various programs necessary to control the server 302 and data tables. And the RAM 306 is a memory to temporarily store various data calculated by the CPU 304.

And to the CPU 304, a clock pulse generator 307 for generating standard clock pulses and a frequency divider 308 are connected, and a random number generator 309 for generating random numbers and a random number sampling circuit 310 are connected. The random number sampled through the random number sampling circuit 310 is used in various lotteries such as Jack Pot-ceiling value symbol combination.

And to the CPU 304, the server communication circuit 303 is connected. Here, the server communication circuit 303 converts a signal sent by the server 302 into a communicable signal corresponding to a communication manner for telephone network or LAN cable. The server communication circuit 303 sends such signal to each of the slot machines 1, receives the signal sent from the slot machine 1 and reconverts the signal so that the server 302 can read. And the server communication circuit 303 is connected to each slot machine 1 through the game communication circuit 303 of each slot machine 1 and the network 401 with bilateral communication ability such as Internet.

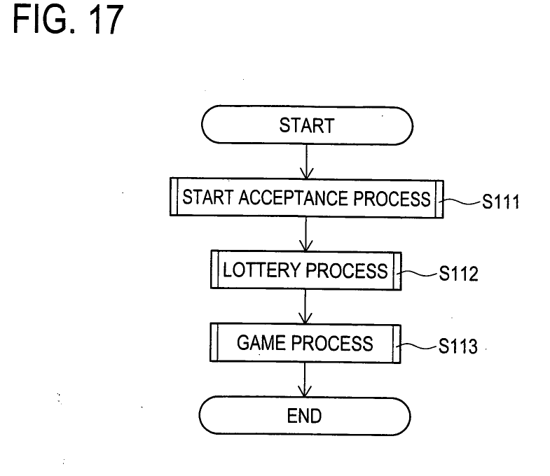

Next, a main process program executed in each of the slot machines 1 of the slot system 301 will be described with reference to FIG. 17. FIG. 17 is a flowchart of the main process program. Here, processes in S111˜S113 of FIG. 17 are as same as the processes in S11˜S13 of FIG. 7, therefore explanation thereof will be omitted.

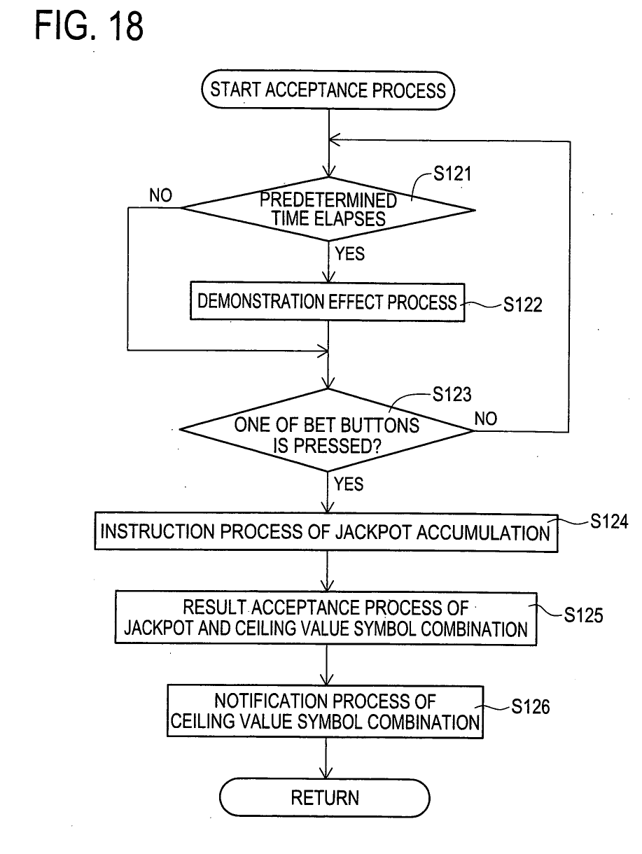

Next, a start acceptance process program conducted in each slot machine 1 of the slot system 301 will be described with reference to FIG. 18. FIG. 18 is a flowchart of the start acceptance process program. The start acceptance process is conducted in S111 of the main process program in FIG. 17. In this start acceptance process in S111, at first, processes of S121˜S123 in FIG. 18 are sequentially conducted. Here, the processes in S121˜S123 are as same as those in S21˜S23, thus explanation thereof will be omitted.

Therefore, when the HELP button 8 is pressed during the game, the total number of times N of the game is displayed on the liquid crystal display 3. Here, the total number of times N of the game is a total number obtained in the server 302 by adding the number of times of the game conducted in each of the slot machines 1. Thus, if the HELP button 8 is pressed during the game, it is displayed on the liquid crystal display 3 the total number of times N of the game (total number of the game conducted in each of the slot machines 1 in the slot system 301) which is updated and received from the server 302 at that timing.

And in S124, a Jack Pot accumulation instruction process is conducted, and the slot machine 1 sends an instruction (including information of number of coins betted) to add a part of coins betted (worth equivalent thereto) in the slot machine 1 to the progressive Jack Pot and individual information of the slot machine 1 are sent to the server 302. Thereafter, procedure shifts to S125.

And in S125, it is conducted a Jack Pot and ceiling value symbol combination result acceptance process, thereby the slot machine 1 receives information indicating that the Jack Pot or the ceiling value symbol combination is won, a value of the progressive Jack Pot, the total number of times N of the game and three numbers of times of the game to start the ceiling value symbol combination, from the server 302.

Further, in S126, it is conducted the process to notify the ceiling value symbol combination. In this process, when the total number of times N of the game reaches to a predetermined number of times of the game smaller than the value determined as the number of times of the game to start the ceiling value symbol combination, it is thereafter notified to the player every the game is conducted that the payout for the ceiling value symbol combination is given, by displaying the tables shown in FIG. 11 on the liquid crystal display 3. Concretely, for example, in a case that three numbers of times of the game to start the ceiling value symbol combination, which are received in the process to notify the ceiling value symbol combination of S125, are respectively “700”, “200”, “600”, when the total number of times N of the game becomes “190” which is smaller than “200” by “10”, the tables shown in FIG. 11 are displayed on the liquid crystal display 3 every the total number of times N of the game is received till the total number of times N of the game reaches to “200”. And when the total number of times N of the game becomes “570” which is smaller than “600” by “30”, the tables shown in FIG. 11 are displayed on the liquid crystal display 3 every the total number of times N of the game is received till the total number of times N of the game reaches to “600”. Further, when the total number of times N of the game becomes “650” which is smaller than “700” by “50”, the tables shown in FIG. 11 are displayed on the liquid crystal display 3 every the total number of times N of the game is received till the total number of times N of the game reaches to “700”.

Thereafter, procedure returns to the main process program of FIG. 17 and shifts to the lottery process in S112.

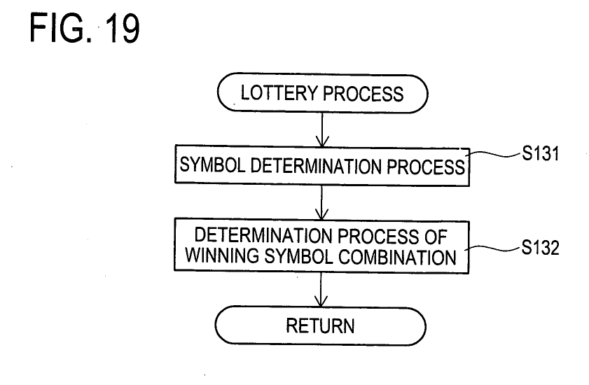

Next, the lottery process program conducted in each slot machine 1 of the slot system 301 will be described with reference to FIG. 19. FIG. 19 is a flowchart of the lottery process program. In S112 of the main process program in FIG. 17, the lottery process is conducted. At that time, at first, processes of S131 and S132 in FIG. 19 are conducted. Here, the processes of S131 and S132 are as same as those of the processes of S31 and S32, thus explanation thereof will be omitted.

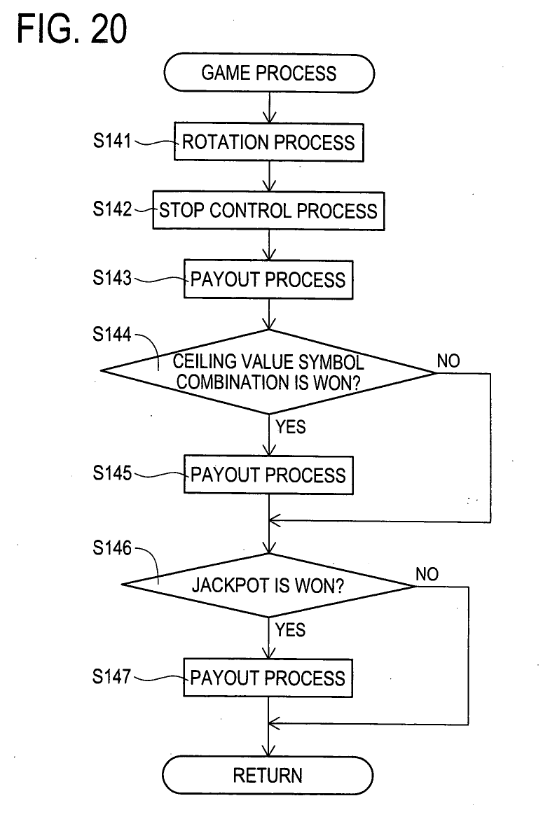

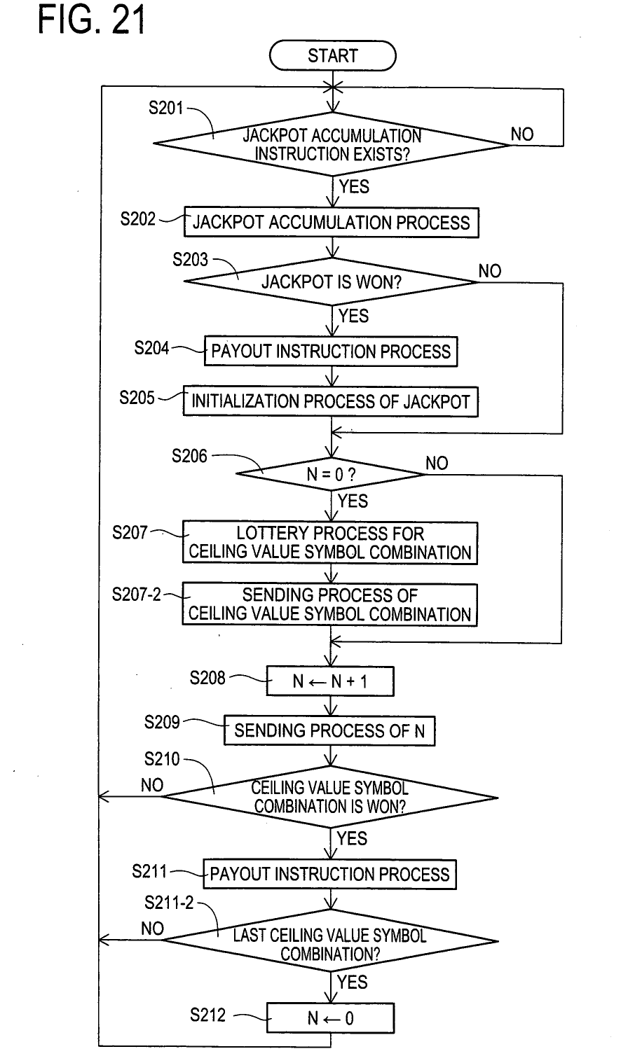

Next, a game process program done in each slot machine 1 of the slot system 301 will be described with reference to FIG. 20. FIG. 20 is a flowchart of the game process program. Here, in S113 of the main process program in FIG. 17, the game process is conducted. At that time, at first, each of processes in S141˜S143 is sequentially conducted. Here, the processes in S141˜S143 are as same as those in S41˜S43 of FIG. 10, thus explanation thereof will be omitted.

And in S144, it is determined whether or not the ceiling value symbol combination is won. This determination is done based on whether or not it is received from the server 302 in S125 of FIG. 18 the information indicating that the ceiling value symbol combination is won. Here, if it is determined that the ceiling value symbol combination is not won (S144: NO), procedure shifts to S146. On the other hand, if it is determined that the ceiling value symbol combination is won (S144: YES), coins (for example, 500 coins) corresponding to the payout which is preset based on the tables in FIG. 11 are paid out in S145, thereafter procedure shifts to S146.

And in S146, it is determined whether or not the Jack Pot is won. This determination is done based on whether or not it is received from the server 302 in S125 of FIG. 18 the information indicating that the Jack Pot is won. Instead of this, for example, it may be determined that the Jack Pot is won only if the winning symbol combination “7-7-7” is won in S112 of FIG. 17.

And in S146, if it is determined that the Jack Pot is not won (S146: NO), the main process program of FIG. 17 is terminated, thereafter the main process program of FIG. 17 is newly started. On the other hand, if it is determined that the Jack Pot is won (S146: YES), coins corresponding to the value of the progressive Jack Pot received from the server 302 in S125 of FIG. 18 are paid out, thereafter the main process program of FIG. 17 is terminated, and the main process program of FIG. 17 is newly started.

Next, a Jack Pot and ceiling value symbol combination lottery process, which is conducted in the server 302 of the slot system 301, will be described with reference to FIG. 21. FIG. 21 is a flowchart of the Jack Pot and ceiling value symbol combination lottery process. In FIG. 21, at first, it is determined whether or not the Jack Pot accumulation instruction exists in S201. This determination is done based on whether or not it is received the instruction (including information of number of coins betted), which is sent from any of the slot machines 1 in S124 of FIG. 18, to add a part of coins (worth equivalent thereto) betted to the progressive Jack Pot.

Here, if it is determined that the Jack Pot accumulation instruction does not exist (S201: NO), procedure returns to S201 itself and waits till the Jack Pot accumulation instruction occurs. On the other hand, if it is determined that the Jack Pot accumulation instruction exists (S201: YES), procedure shifts to a Jack Pot accumulation process in S202 and a part (equivalent worth) of coins received is added to the progressive Jack Pot. Here, the progressive Jack Pot is stored in a memory area of the RAM 306.

And in S203, it is determined whether or not the Jack Pot is won. In this determination, it is determined that the Jack Pot is won only in a case that the random umber value sampled within a range of 0˜1023 through the random number sampling circuit 310 is “0”. Here, if it is determined that the Jack Pot is not won (S203: NO), procedure shifts to S206. On the other hand, if it is determined that the Jack Pot is won (S203: YES), procedure shifts to S204. In a payout instruction process of S204, it is sent to the slot machine 1, which is a sender of the instruction received by the server 302, the information indicating that the Jack Pot is won and the value of the progressive Jack Pot accumulated up to now. And in an initialization process of the Jack Pot in S205, “0” is substituted for the progressive Jack Pot, thereby the progressive Jack Pot is reset.

Thereafter, procedure shifts to S206 and it is determined whether or not the total number of times N of the game is “0”. Here, if it is determined that the total number of times N of the game is not “0” (S206: NO), procedure shifts to S208. On the other hand, if it is determined that the total number of times N of the game is “0” (S206: YES), procedure shifts to S208 after a ceiling value symbol combination lottery process is conducted.

The ceiling value symbol combination lottery process in S207 will be described. In the lottery process for ceiling value symbol combination in S207, three random number values are sampled within a range of 0˜127 through the random number sampling circuit 310, and three numbers of times of the game to start the ceiling symbol combination are respectively determined based on the three tables shown in FIG. 11. Concretely speaking, if the first random number value sampled through the random number sampling circuit 310 lies in a range of 0˜25, “100” is determined as the number of times of the game to start the ceiling value symbol combination based on the upper table in FIG. 11. And if the second random number value sampled through the random number sampling circuit 310 lies in a range of 26˜63 , “500” is determined as the number of times of the game to start the ceiling value symbol combination based on the middle table in FIG. 11. Further, if the third random number value sampled through the random number sampling circuit 310 lies in a range of 64˜127, “900” is determined as the number of times of the game to start the ceiling value symbol combination based on the lower table in FIG. 11. That is to say, three values of the number of times of the game to start the ceiling value symbol combination are determined in the lottery process for the ceiling value symbol combination in S207.

Here, the ceiling value symbol combination is a symbol combination through which a payout is given when the total number of times N of the game reaches to the value determined as the number of times of the game to start the ceiling value symbol combination. For example, in the lottery process for the ceiling value symbol combination in S207, if three of the number of times of the game to start the ceiling value symbol combination, each of which is determined based on each of three tables in FIG. 11, are respectively “400”, “800”, “300”, every the total number of times N of the game becomes “300”, “400” and “800”, the payout of “500” is given.

However, as mentioned, the total number of times N of the game is the total number of times obtained by adding the number of times conducted in each of the slot machines 1 of the slot system 301. Therefore, there will be probable that the slot machine 1 can obtain the payout of the ceiling value symbol combination, if the total number of times N of the game counted by the server 302 becomes any one of “100”, “2002, “300”, “400”, “500”, “600”, “700”, “800”, “900” when the game is conducted in such slot machine 1. Here, the tables shown in FIG. 11 are stored in the ROM 305 and the total number of times N of the game is stored in a memory area of the RAM 306.

And in the lottery process for the ceiling value symbol combination in S207, the lottery of plural numbers of times of the game to start the ceiling value symbol combination may be conducted beforehand through the random number sampling circuit 310, thereafter three of the number of times of the game to start the ceiling value symbol combination may be determined by a lottery among such plural numbers of times of the game to start the ceiling value symbol combination. Here, in this case, the lottery done beforehand may be conducted right before three of the number of times of the game to start the ceiling value symbol combination are determined within the lottery process for the ceiling value symbol combination of S207, or for example, may be conducted when the total number of times N of the game is reset in S212 mentioned later by substituting the number N for “0”.

And in S207-2, three numbers of times of the game necessary to start the ceiling value symbol combination determined in S207 are sent to the slot machine which a sender of the instruction received by the server 302 in S201.

Further, in S208, “1” is added to the total number of times N of the game at present, thereby the total number of times N of the game in the present game is calculated. And in S209, the total number of times N of the game in the present game is sent to the slot machine which is a sender of the instruction received by the server 302 in S201.

In S210, it is determined whether or not the ceiling value symbol combination is won. This determination is done whether or not the total number of times N of the game calculated in S208 coincides with any of three numbers of times of the game to start the ceiling value symbol combination determined in S207. Here, if it is determined that the ceiling value symbol combination is not won (S210: NO), procedure returns to S201 and processes mentioned in the above are repeated. On the other hand, if it is determined that the ceiling value symbol combination is won (S210: YES), procedure shifts to S211. In a payout instruction process of S211, the information indicating that the ceiling value symbol combination is won is sent to the slot machine 1 which is a sender of the instruction received by the server 302 in S201. Further, in S211-2, it is determined whether or not the ceiling value symbol combination won in S210 is the last ceiling value symbol combination. This determination is done based whether or not the total number of times N of the game calculated in S208 is the maximum number of times of the game to start the ceiling symbol combination among three numbers of times of the game to start the ceiling symbol combination determined in S207. Here, if it is determined that the ceiling value symbol combination is not the last ceiling value symbol combination (S211-2: NO), procedure returns to S201. On the other hand, if it is determined that the ceiling value symbol combination is the last ceiling value symbol combination (S211-2: YES), “0” is substituted for the total number of times N of the game in S212, thereby the total number of times N of the game is reset. Thereafter, procedure returns to S201 and processes mentioned in the above are repeated.

As mentioned in detail, in the slot system 301 of the embodiment, a part of coins (worth equivalent thereto) betted in the slot machine 1 is added to the progressive Jack Pot in the server 302 (S207), thereafter if it is determined that the progressive Jack Pot is won (S47: YES), coins (for example, 10000 coins) corresponding to the progressive Jack Pot accumulated up to now are paid out in the slot machine 1 (S204, S147). Here, as a condition to win the progressive Jack Pot, it is limited to a case that the random number value sampled within a range of 0˜1023 through the random number sampling circuit 310 is “0” in the server 302. Therefore, in many cases, the progressive Jack Pot becomes enormous, thus although the real pleasure for a dream of making a fortune at a stroke can be given to a player, on the contrary, even if the player really continues to play games while aiming the progressive Jack Pot, there will be scarcely a case that the player can get luck to obtain the progressive Jack Pot. Therefore, the player generally gives up from the first to obtain realizing of the progressive Jack Pot.

However, in the slot system 301 of the embodiment, three numbers of times of the game to start the ceiling value symbol combination are determined (S207) based on the lottery using three random number values sampled within a range of 0˜127 through the random number sampling circuit 310 and three tables of FIG. 11, and coins corresponding to the payout which is preset, are paid out (S211, S145) based on the tables in FIG. 11, every the total number of times N of the game reaches to each of three numbers of times of the game to start the ceiling symbol combination (S210). Thereby, if the player continues 900 slot games at maximum to aim the ceiling value symbol combination, the player can surely win the ceiling value symbol combination in three times. Therefore, even if the player gives up realizing to obtain the progressive Jack Pot that a part of coins (worth equivalent thereto) betted is accumulated every the game, interest of the player to continue the slot games can be sufficiently aroused.

Here, the payout corresponding to the ceiling value symbol combination may be set to the same value shown in FIG. 11 with no relation to the number of times of the game necessary to start the ceiling value symbol combination. And the payout corresponding to the ceiling value symbol combination may be set different according to the number of times of the game necessary to start the ceiling value symbol combination.

And in the slot system 301 of the embodiment, after the total number of times N of the game reaches to the predetermined number of times of the game smaller than the value determined as the number of times of the game to start the ceiling value symbol combination, it is notified thereafter to the player (S28) in each slot machine 1 every the game is conducted that the payout corresponding to the ceiling value symbol combination is given, by displaying the tables shown in FIG. 11 on the liquid crystal display 3.

Therefore, for example, it is clear for the player that if the effect notification is not started after the total number of times N of the game becomes “90”, the ceiling value symbol combination cannot be won even if the total number of times N of the game becomes “100” and the ceiling value symbol combination can be won after the total number of times N of the game becomes more than “200”. And it is clear that if the effect notification is not started after the total number of times N of the game becomes “190”, the ceiling value symbol combination cannot be won even if the total number of times N of the game becomes “200” and the ceiling value symbol combination can be won after the total number of times N of the game becomes more than “300”. Further, it is clear that if the effect notification is not started after the total number of times N of the game becomes “290”, the ceiling value symbol combination cannot be won even if the total number of times N of the game becomes “300” and the ceiling value symbol combination can be won after the total number of times N of the game becomes more than “400”. Similarly to the above, if the effect notification is not started after the total number of times N of the game becomes “370”, “470”, “570”, “650”, “750” or “850”, it is clear for the player that the same situations as the above occur. Therefore, since an index to win the ceiling value symbol combination is provided, interest of the player to continue the slot games can be sufficiently aroused.

Here, the manner of the effect notification corresponding to the number of times of the game to start the ceiling value symbol combination are described as an example, thus it is not limited to this. For example, when the tables shown in FIG. 11 are displayed on the liquid crystal display 3, it may be displayed the difference between the total number of times N of the game at present and the number of times of the game to start the ceiling value symbol combination which is the nearest to the number N.

And in the slot system 301 of the embodiment, the total number of times N of the game calculated by the server 302 is calculated on the basis of the games (which are calculation object) conducted in each of the slot machines 1, thus the total number of times N of the game comparatively rapidly reaches to “100”, “500”, “1000”, in comparison with a case that the number of times of the game done in independent slot machine 1 becomes the calculation object. Therefore, interest of the player to continue the slot games can be sufficiently aroused.

Here, the present invention is not limited to the embodiment and various changes, modifications can be done within the scope of the present invention.

For example, in the slot system 301 of the embodiment, although three numbers of times of the game to start the ceiling value symbol combination are determined (S207) by using three tables shown in FIG. 11 in which plural numbers of times of the game to start the ceiling value symbol combination are provided, it may be used one table in which many numbers of times of the game to start the ceiling value symbol combination are provided. And the number of times of the game to start the ceiling value symbol combination may be set to only one, and when the number of times of the game necessary to start the ceiling value symbol combination may be determined (S207), for example, such one number of times of the game to start the ceiling value symbol combination may be determined based on one table shown in FIG. 12.

And in the slot system 301 of the embodiment, when the HELP button 8 is pressed in each slot machine 1 during the game, the total number of times N of the game is displayed on the liquid crystal display 3. Here, the total number of times N of the game may not be displayed. In this case, the player cannot acknowledge the number of times N of the game and has feeling as if coins corresponding to the payout of the ceiling value symbol combination are suddenly paid out, therefore the player expects sudden payout of coins, thereby interest of the player to. continue the slot games can be sufficiently aroused.

And in the slot system 301 of the embodiment, although the value determined as the number of times of the game necessary to start the ceiling value symbol combination is corresponded to the total number of times N of the game, instead of this, such value may be corresponded to the value of the progressive Jack Pot with a specific manner such as “1111”, “2222”, . . . , “9999”, “1000”, “2000”, . . . , “9000”. However, in this case, coins paid out for the ceiling value symbol combination are subtracted from the progressive Jack Pot.

And in each slot machine 1 of the slot system 301 according to the embodiment, the symbols stopped and displayed on the activated pay line L are determined in the lottery process of S112 every each of the variable display portions 22, 23, 24 based on the random number values sampled through the random number sampling circuit 56. Here, all symbols stopped and displayed on the activated pay line L in the variable display portions 22, 23, 24 may be determined based on the random number value sampled through the random number sampling circuit 56. In order to realize this, a lottery table of the winning symbol combinations shown in FIG. 13 is used. Here, since explanation of FIG. 13 is already described in the above, explanation thereof will be omitted.

And in each slot machine 1 of the slot system 301 according to the embodiment, although the base game is done, for example, a free game may be done right after the process of S113 in FIG. 17 after the base game is conducted. Here, in the free game, games beneficial for the player are generally conducted, and for example, when the free game occurs based on a condition that a specific symbol is stopped and displayed, games are continuously conducted for 10 games, 20 games or 30 games according to a rank of the free game. At that time, in the free game, a winning probability to win various winning symbol combinations is generally set high, therefore the player can obtain many coins.

And in the slot system 301 of the embodiment, if it is determined that the ceiling value symbol combination is won (S210: YES), coins corresponding to the payout which is preset are paid out based on the tables shown in FIG. 11 (S211, S143). Here, as the payout, instead of coins, the free game mentioned in the above may be conducted in a continuous number of times which is preset.

Further, although each slot machine 1 of the slot system 301 according to the embodiment is constructed as a mechanical reel type slot machine in which the symbols formed on the peripheries of the reels 220 controlled to rotate are variably displayed and stopped through the variable display portions 22 to 24, the slot machine 1 may be constructed as a video reel type slot machine in which the image symbols are variably displayed and stopped in each of the variable display portions 22 to 24.

And in the slot system 301 of the embodiment, it is determined whether or not both of the Jack Pot and ceiling value symbol combination are won (S203, S210). Here, it may be independently determined in each slot machine 1 whether or not the ceiling value symbol combination is won, including calculation of the total number of times N of the game, or it may be independently determined in each slot machine 1 whether or not the progressive Jack Pot is won, including calculation of the value of the progressive Jack Pot.

And in the slot system 301 of the embodiment, although the server 302 different from the slot machine 1 constructs a part of the system, function of the server 302 may be charged by any of the slot machines 1 and the server 302 may be excluded.

The present invention can be adopted for technology of a gaming machine in which the progressive Jack Pot is utilized.

What is claimed is:

1. A gaming machine comprising:
a display device for variably displaying and stopping symbols based on a bet amount;
a processor programmed to operate with the display device (a) to conduct a lottery to determine a stop display manner of the symbols on the display device, (b) to control the display device to stop the symbols according to the stop display manner, (c) to give a payout based on the stop display manner of the symbols, (d) to conduct a lottery to determine whether or not a progressive Jack Pot to which a part of the bet amount is accumulated every a game is won, (e) to pay out the progressive Jack Pot when the progressive Jack Pot is won, (f) to conduct a lottery to determine at least one threshold among plural thresholds, and (g) to give a predetermined award different from the payout based on the stop display manner and the progressive Jack Pot when the threshold is realized.

2. The gaming machine according to claim 1, wherein the threshold is defined as a number of times of the game.

3. The gaming machine according to claim 2, wherein the processor extracts beforehand plural numbers of times of the game, and gives the predetermined award every a total number of times of the game reaches to one of the numbers of times of the game.

4. The gaming machine according to claim 3, further comprising:
plural tables in each of which plural numbers of times of the game are provided;
wherein the processor determines one number of times of the game from each of the tables, and gives the predetermined award every the total number of times of the game reaches to the one number of times of the game.

5. The gaming machine according to claim 4, wherein the processor determines whether or not the total number of times of the game coincides with a maximum number of times of the game among plural numbers of times of the game, and resets the total number of times of the game when the total number of times of the game coincides with the maximum number of times of the game.

6. The gaming machine according to claim 2, wherein the processor starts notification indicating that the predetermined award is given when the total number of times of the game reaches to a predetermined value smaller than the number of times of the game.

7. A gaming system in which plural gaming machines and a server are connected,
wherein each of the gaming machine comprising;
a display device for variably displaying and stopping symbols based on a bet amount; and
a gaming machine processor programmed to operate with the display device (a) to conduct a lottery to determine a stop display manner of the symbols on the display device, (b) to control the display device to stop the symbols according to the stop display manner, and (c) to give a payout based on the stop display manner of the symbols;
wherein the server comprising:
a server processor (d) to conduct a lottery to determine whether or not a progressive Jack Pot to which a part of the bet amount betted in each of the gaming machines is accumulated every a game is won, (e) to pay out the progressive Jack Pot to the gaming machine that a part of the bet amount is accumulated to the progressive Jack Pot when the progressive Jack Pot is won, (f) to conduct a lottery to determine at least one threshold among plural thresholds, and (g) to give to the gaming machine that a part of the bet amount is accumulated to the progressive Jack Pot a predetermined award different from the payout based on the stop display manner and the progressive Jack Pot when the threshold is realized.

8. The gaming system according to claim 7, wherein the threshold is defined as a number of times of the game.

9. The gaming system according to claim 8, wherein the server processor extracts beforehand plural numbers of times of the game, and gives the predetermined award to the gaming machine that a part of the bet amount is accumulated to the progressive Jack Pot every a total number of times of the game reaches to one of the numbers of times of the game.

10. The gaming system according to claim 9, further comprising:
plural tables provided in the server, in each of the tables plural numbers of times of the game being provided;
wherein the server processor determines one number of times of the game from each of the tables, and gives the predetermined award to the gaming machine that a part of the bet amount is accumulated to the progressive Jack Pot every the total number of times of the game reaches to the one number of times of the game.

11. The gaming system according to claim 10, wherein the server processor determines whether or not the total number of times of the game coincides with a maximum number of times of the game among plural numbers of times of the game, and resets the total number of times of the game when the total number of times of the game coincides with the maximum number of times of the game.

12. The gaming system according to claim 8, wherein the gaming machine processor starts notification indicating that the predetermined award is given when the total number of times of the game reaches to a predetermined value smaller than the number of times of the game.
